(19) United States
(12) Patent Application Publication
(10) Pub. No.: US 2023/0133468 A1
(43) Pub. Date: May 4, 2023

(54) ELECTRICAL CONNECTING STRUCTURE AND METHOD FOR PRODUCING SUCH A STRUCTURE

(71) Applicant: INTERPLEX NAS ELECTRONICS GMBH, Heilbronn (DE)

(72) Inventor: Michael NIELSEN, Heilbronn (DE)

(21) Appl. No.: 17/912,263

(22) PCT Filed: Jan. 20, 2021
(86) PCT No.: PCT/EP2021/051193

§ 371 Date: Sep. 16, 2022

(30) Foreign Application Priority Data
Mar. 26, 2020 (DE) 10 2020 108 421.8

(51) Int. Cl. H01R 4/62; B32B 15/01; C23C 24/04

(52) U.S. Cl. CPC H01R 4/62; B32B 15/016; C23C 24/04; H01R 4/30

(57) ABSTRACT

An electrical connecting structure (10) for use as a means for transmitting electrical energy between a first electrical component and a second electrical component, wherein the connecting structure (10) is formed from a number of layers (20, 30, 40, 50) arranged serially with one another, a first outer layer (20) consisting of aluminum or an aluminum alloy and a second outer layer (50) preferably consisting of aluminum or an aluminum alloy, and a third and preferably fourth layer (30, 40), specifically one or two inner layers, being provided between the outer layers (20, 50), the inner layer or inner layers (30, 40) being respectively produced by cold gas spraying.

### CROSS-REFERENCE TO RELATED APPLICATIONS

This application is a 371 U.S. National Phase of International Application No. PCT/EP2021/051193, filed Jan. 20, 2021, which claims priority to German Patent Application No. 10 2020 108 421.8, filed Mar. 26, 2020. The entire disclosures of the above applications are incorporated herein by reference.

### BACKGROUND

The disclosure relates to an electrical connecting structure and a method for producing such a structure.

Various connection solutions are used in the prior art for connecting mutually separate elements between an electrical energy source and an electrical energy sink. In addition to the traditional non-detachable methods, such as soldering or welding, there are so-called detachable electrical connections, such as plug connections, screw connections, clinch connectors, crimp connectors, to name just a few.

In various applications, such as battery connections, busbars, and power distributors, there is always a mix of materials in the components to be connected. This leads to corrosion issues and the associated problems. In particular, connection to aluminum as a conductor material has not been adequately resolved in the prior art.

Many attempts have been made to solve the connection problem, for example in body construction, between different materials while retaining the existing resistance spot welding systems, particularly for aluminum and steel. Some well-known techniques are presented below. In patent DE 10015713 A1, a method was disclosed where a full rivet is introduced into the aluminum sheet. The aim is to create an I-shape that clamps the aluminum sheet. The aluminum sheet is then welded to another steel sheet via the steel rivet element using resistance spot welding. This rivet element has two flat surfaces.

Other methods exist for combining metallic materials with one another. With roll bonding, for example, two or more different materials are combined with one another in order to enable the best properties of the individual materials to be exploited. Even materials that are not normally easy to weld can be connected to one another by incorporating intermediate layers. This applies both to full-surface and strip-shaped designs. This is the reason that at least two different metal strips are combined to form a composite material during plating. The materials typically travel in parallel from the respective coil into the rolling mill and, depending on the metal and material properties, are bonded together by high rolling pressure.

Materials such as precious metals or precious metal alloys based on gold, palladium, and silver, as well as copper and copper alloys, nickel, aluminum, and aluminum-silicon can be used for the coating. However, the method is not suitable for use with a power rail or a power distributor, since the connection points at issue have bolts and/or bores, for example, in order to connect the connection partners using a screw bolt and a nut. Further material combinations occur as a result, and various surface portions at the points of connection are not covered by the roll bonding.

Another alternative for coating the materials is galvanic coating. However, there is no satisfactory solution for various conductor materials and aluminum in the prior art to solve the aforementioned problem in an economical and cost-effective manner and, in particular, to adequately reduce or almost completely avoid the consequences of corrosion resulting from the electrochemical voltage potentials between the contact materials.

From the field of connection technology, one solution for improving the problems for a mechanical connection, namely a screw, is proposed in WO 2013083540 A1. Such a screw has sufficient strength on the one hand and adequate corrosion resistance on the other. Advantageously, the material of the screw can be resistant, particularly to contact corrosion, with carbon or carbon-reinforced composite materials. Since carbon, due to its electrochemical potential, is an unfavorable partner for iron, it is particularly important for the long-term use of the screw that this type of corrosion be avoided, regardless of whether or not the environment is also corrosive. Advantageously, the screw can be made of a high-temperature-resistant material according to EN 10269 or the like, particularly of an austenitic material or of a nickel-based alloy.

Such material pairings are not suitable for the transmission of electrical power and high currents. On the contrary, contact corrosion also has the disadvantageous effect that the transfer resistance in the area of the contact surfaces of the contact partners changes, in particular increases, and heating then increasingly occurs at the contact point. This sometimes leads to significant consequential damage.

Numerous solutions can be found in the prior art, which, however, cannot be applied to electrical connections. For instance, WO 1995000678A1 describes a method for producing corrosion-protected metallic materials through passivation. Here, a layer of an intrinsically conductive polymer is applied to the metallic material. The coated metallic material is then brought into contact with oxygen-containing water until the equilibrium potential is reached. Polyaniline, in particular, is used as the conductive polymer. The conductivity achieved is not sufficient for transferring electrical energy, and aluminum does not lend itself to analogous treatment, either.

In principle, aluminum oxide layers cause considerable problems when connecting contact parts or busbars made of aluminum material. In addition to the abovementioned difficulties associated with increasing resistance, problems also arise due to the fact that there are gaps and voids in the surface contact areas where foreign materials can deposit and which, in turn, form corrosion nuclei and further exacerbate the problem.

In the field of vehicle construction, however, lightweight materials are increasingly required. Recent well-known examples of recall campaigns by vehicle manufacturers show that the problem still exists and has not been adequately solved. Even the well-known PVD and CVD processes have been unable to provide the compelling results for applications in electrical connection materials, busbars, current distributors, and battery terminals.

The disclosure is therefore based on the object of overcoming the aforementioned drawbacks of the prior art and providing a cost-effective, corrosion-resistant connecting structure and a corresponding method for producing such a structure.

This object is achieved by the combination of features according to an electrical connecting structure for transmitting electrical energy between a first electrical component and a second electrical component. The connecting structure comprises a number of layers arranged serially with one another. A first outer layer includes aluminum or an aluminum alloy. A second outer layer preferably includes aluminum or an aluminum alloy. A third and preferably fourth layer, specifically one or two inner layers, are between the outer layers. The inner layer or inner layers are, respectively, produced by cold gas spraying.

One basic idea of the disclosure is to form a specific structure where a connection zone occurs between a first and second inner layer of two connection partners that were produced by cold gas spraying.

According to the disclosure, an electrical connecting structure is used for transmitting electrical energy between a first electrical component and a second electrical component. The connecting structure is formed from a number of layers arranged serially with one another. A first outer layer, includes aluminum or an aluminum alloy, and a second outer layer, preferably includes aluminum or an aluminum alloy, and a third and preferably fourth layer, specifically one or two inner layers, are between the outer layers. The inner layer or inner layers are respectively produced by cold gas spraying. This yields a composite material that has particularly good corrosion properties. Alternatively, however, as pointed out, it is also possible for only one aluminum or one aluminum alloy layer to be provided, as well as any combination with other materials such as Cu—Al, for example.

The same applies to the specified cold gas layers. It would also be conceivable to provide only one inner cold gas layer on one aluminum or one aluminum alloy layer. Consequently, only one cold gas layer would be required for applications such as those with a combination of copper or copper alloys as the connection partners.

In one preferred embodiment of the disclosure, the two inner layers are interconnected directly through contact with one another (i.e., without further layers in between).

In another preferred embodiment of the disclosure, the electrical connecting structure is designed as a connecting structure that can be detached at least between two of the four layers. It can be separated from a connection position (connected state) into a separation position (pre-assembly state or separated state) and whose corresponding contact surfaces are designed such that they form a nonpositive and/or positive connection in the non-separated connection position. With these designs, the two connection partners can be separated from one another as intended (formed from an aluminum or, similar to a connector that is or can be connected for the purpose of plugging and unplugging.

In order to establish a connection that is permanently protected from corrosion, the two connection partners are brought into contact with their anticorrosion coatings, produced by cold gas spraying, in order to then act as an electrical connection, for example between two devices or an electrical energy source and an electrical energy sink.

In an alternative embodiment of the disclosure, the electrical connecting structure is designed as a non-releasable, particularly integral connecting structure where the two inner anticorrosion coatings are held together by atomic or molecular forces.

In the alternative embodiment of the disclosure described above, where a nonpositive connection is provided, in order to produce the nonpositive connection, a connecting mechanism, particularly a connecting bolt, runs through all layers (as viewed in the direction of energy flow during current flow). An opening is provided in each layer through which the connecting bolt penetrates.

The structure of the arrangement is designed in such a way that the second inner layer is applied to the first outer layer by cold gas spraying. Particularly, this covers the latter completely up to the edge region. The third inner layer is applied to the second outer layer by cold gas spraying. This also covers the latter completely up to the edge region.

The connection partners formed in this manner can form a fully or at least partially corresponding contact surface for the electrical connection. The areas can preferably be of the same size, although partial contact would also be possible from only one subarea.

It is also advantageous if the two outer layers have a substantially greater thickness in their direction of thickness (in the series direction of the serially arranged layers) than the inner layers, particularly in a ratio of greater than 1:10. In other words, this means that a comparatively thick layered structure is formed by the aluminum or aluminum alloy onto which a comparatively thin layer, specifically as a functional anticorrosion coating, is sprayed using the cold gas spraying process. The optimum combination of material and thickness is matched to the respective application. If, in addition, a particularly high mechanical strength is required, the outer layers or structures can be made correspondingly thick and solid. In particular, this can also bring advantages with regard to the thermal properties of the electrical connecting structure and the desired heat transport when used with high currents.

In this respect, the concept of the disclosure is particularly suitable for implementing a busbar or a current distributor between at least two lines. Each of the two connection partners is connected to an electrical line that leads to an energy source or sink, such as a battery or an electrical consumer.

In addition to the connecting structure as such, another aspect of the present disclosure also relates to a method for producing such an electrical connecting structure comprising the following steps:

a) providing two outer layers or layer-like structures made of aluminum or an aluminum alloy;

b) applying a respective anticorrosion coating by cold gas spraying to the respective surface of the two outer layers or structures;

c) connecting the two anticorrosion coatings to produce a connecting structure by forming a series of layers that are arranged one behind the other in the connected state.

This method is also advantageous if, in step c), a nonpositive connection, positive connection, and/or integral connection is produced.

Other advantageous refinements of the disclosure are characterized in the subclaims and/or depicted in greater detail below together with the description of the preferred embodiment of the disclosure with reference to the figures.

### DRAWINGS

FIG. 1 is a schematic view of an electrical connecting structure in a pre-assembly state (separated state);

FIG. 2 is a schematic view of a first exemplary embodiment of an electrical connecting structure in a nonpositively connected state;

FIG. 3 is a schematic view of an alternative exemplary embodiment of an electrical connecting structure in a positively connected state; and

FIG. 4 is a schematic view of another alternative exemplary embodiment of an electrical connecting structure in an integrally connected state.

### DETAILED DESCRIPTION

In the following, the disclosure will be discussed in greater detail with reference to FIGS. 1 to 4, with same reference symbols referring to similar structural and/or functional features.

FIG. 1 is an exemplary schematic illustration of an electrical connecting structure 10 in a pre-assembly state (separated state). The two connection partners 10a, 10b form the connecting structure 10 in the connected state.

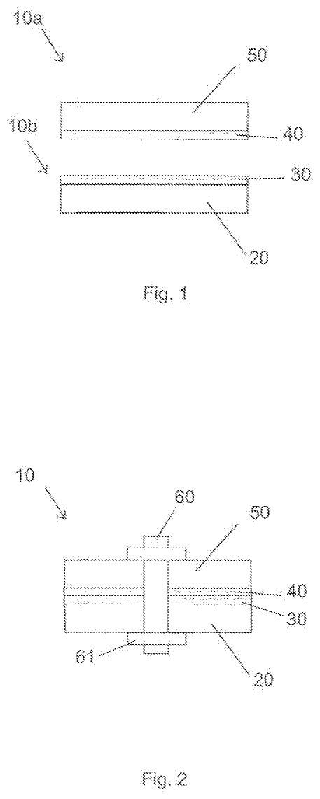

The exemplary embodiments shown in FIGS. 2 to 4 each show a schematic view of an electrical connecting structure 10 for transmitting electrical energy between a first and second electrical component (which is not shown in detail here).

As can be seen clearly in the figures, the connecting structure 10 is formed from a plurality of layers 20, 30, 40, 50 that are arranged in series with one another. The layers 20, 30, 40, 50 will be briefly explained below.

The bottom layer represents a first outer layer 20, while the upper layer represents a second outer layer 50. The two outer layers 20, 50 could also be embodied as layered structures.

These layers 20, 50 or structures 20, 50 are made of aluminum or an aluminum alloy.

As can be seen in FIG. 1, there is an anticorrosion coating 30, 40 produced by cold gas spraying on each of the two layers 20, 50, that rests against one another in the connected state according to FIGS. 2 to 4 and then form inner layers 30, 40.

FIG. 2 shows an exemplary embodiment of an electrical connecting structure 10 that is produced via a nonpositive connection. For this purpose, a connecting mechanism 60, particularly a connecting bolt 60, is fastened by a nut 61 to the upper and lower outer structure 20, 50. The bolt 60 runs through all of the layers 20, 30, 40, 50.

In each layer or structure, there is a corresponding opening through which the connecting bolt 60 penetrates.

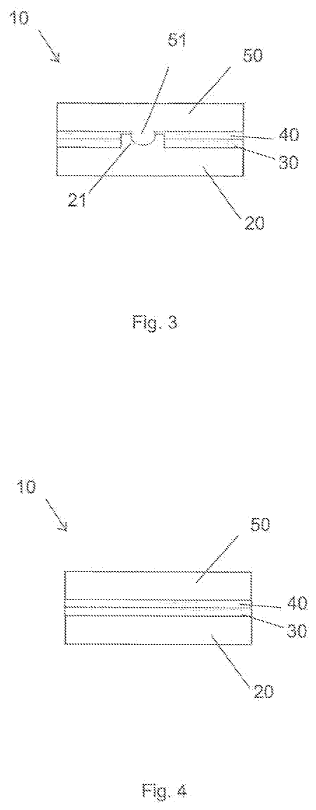

FIG. 3 shows an exemplary embodiment of an electrical connecting structure 10 that is produced via a positive connection. For this purpose, a structural element 11 and a corresponding structural element 51 are provided on the respective outer structures or layers 20, 50. These structural elements engage positively in one another.

FIG. 4 shows an exemplary embodiment of an electrical connecting structure 10 that is produced via a material or integral connection. For this purpose, the two inner layers 30, 40 are connected to one another by a corresponding substance-to-substance process.

The disclosure is not limited in its execution to the abovementioned preferred exemplary embodiments. Rather, a number of variants are conceivable that make use of the illustrated solution even in the form of fundamentally different embodiments. The materials mentioned can also include other metallic materials without these being mentioned in all possible combinations in the description. In particular, copper and copper alloys are also included.

1.-11. (canceled)

12. An electrical connecting structure for transmitting electrical energy between a first electrical component and a second electrical component, the connecting structure comprises a number of layers arranged serially with one another; a first outer layer includes aluminum or an aluminum alloy, a second outer layer preferably include aluminum or an aluminum alloy; a third and preferably fourth layer, specifically one or two inner layers, are between the outer layers; the inner layer or inner layers respectively produced by cold gas spraying.

13. The electrical connecting structure as set forth in claim 12, wherein the two inner layers are interconnected through contact with one another.

14. The electrical connecting structure as set forth in claim 12, wherein the electrical connecting structure is designed as a connecting structure that can be detached at least between two of the four layers and that can be separated from a connection position into a separation position and whose corresponding contact surfaces are designed such that they form a nonpositive and/or positive connection in the non-separated connection position.

15. The electrical connecting structure as set forth in claim 12, wherein the electrical connecting structure is designed as a non-detachable, particularly integral connecting structure.

16. The electrical connecting structure as set forth in claim 14, wherein in order to produce a nonpositive connection, a connecting mechanism, particularly a connecting bolt, runs through all layers, and an opening in each layer through which the connecting bolt penetrates.

17. The electrical connecting structure as set forth in claim 12, the second inner layer is applied to the first outer layer by cold gas spraying, particularly completely covering it up to the edge region.

18. The electrical connecting structure as set forth in claim 12, wherein the third layer is applied to the second outer layer by cold gas spraying, particularly completely covering it up to the edge region.

19. The electrical connecting structure as set forth in claim 12, where the two outer layers have a substantially greater thickness in their direction of thickness, in series direction of serially arranged layers, than the inner layers, particularly in a ratio of greater than 1:10.

20. The electrical connecting structure as set forth in claim 12, wherein the electrical connections structure is embodied as a busbar or current distributor between at least two lines, and one respective connecting line leads to each of the outer layers.

21. A method for producing an electrical connecting structure as set forth in claim 12, comprising the following steps:
d) providing two outer layers or layered structures of aluminum or an aluminum alloy;
e) applying a respective anticorrosion coating to the respective surface of the two outer layers or structures by cold gas spraying;
f) connecting the two anticorrosion coatings to produce a connecting structure by forming a series of layers that are arranged one behind the other in the connected state.

22. The method as set forth in claim 20, wherein the connection in step c) is produced as a nonpositive connection, a positive connection, and/or an integral connection.
